(19) United States
(12) Patent Application Publication
(10) Pub. No.: US 2001/0006711 A1
(43) Pub. Date: Jul. 5, 2001

(54) Process for production of a plastic-coated aluminium foil and packaging made from this

(76) Inventors: Hans-Rudolf Nageli, Neuhausen am Rheinfall (CH); Franz Kolb, Rielasingen (DE); Werner Hammon, Stockach (DE); Werner Hartmann, Hilzingen (DE)

Correspondence Address: Virgil H. Marsh, Fisher, Christen & Sabol, Suite 1401, 1725 K Street, N.W., Washington, DC, 20006, US

(21) Appl. No.: 09/726,372

(22) Filed: Dec. 1, 2000

(30) Foreign Application Priority Data
Dec. 23, 1999 (EP) 99811204.9

(51) Int. Cl. B32B 1/06; B29C 47/06; B29C 47/88

(52) U.S. Cl. 428/35.7; 264/171.21; 264/211.13; 264/211.17; 156/244.24

(57) ABSTRACT

In a process for production of an aluminum foil (10) coated with sealable and sterlisable plastic (14) based on polypropylene (PP) or polyethylene (PE), the plastic (14) is coextruded with an adhesion-promotion agent (16) and combined with an aluminium foil (24) between two rollers (20, 22). The aluminium foil (10) coextrusion-coated in this way, to increase the adhesion strength between the aluminium foil (24) and the plastic layer (14), then passes continuously through an oven (26) with temperature (TO) set such that the temperature of the plastic layer (14) and the adhesion-promotion agent (16) lies above the crystallite melt point (TK) of the plastic. The coated aluminium foil heat-treated in this way, after emerging from the oven (26), is cooled shock-like such that the crystalline proportion at least in the surface area of the cooled plastic layer (14) and the crystallites in this area are as small as possible. A container made of a coated aluminium foil (10) produced with the process for animal feed shows a good serving behaviour on removal of the filling. Also a lid of the coated aluminium foil (10) has low adhesion of the animal feed to the lids which leads to clean opening of the container. Thanks to the essentially suppressed after-crystallisation of the plastic layer (14), white breaks are avoided which increases the resistance to aggressive fillings.

The invention concerns a process for production of an aluminium foil coated with a sealable and sterilisable plastic based on polypropylene (PP) or polyethylene (PE). The scope of the invention also includes packaging made from the coated aluminium foil and its use.

For packing animal feed, containers in the form of cans or dishes with a peel-off lid sealed to the container edge are known. The aluminium foil used as a packaging material is coated with PP on the container inside for sealing and sterilising purposes. Such containers or the PP-coated aluminium foil used for their production are known under the trademark STERALCON®. Previously PP-coated aluminium foil was produced by way of solvent-based lacquer lamination with a PP Castfilm. Here a solvent-based adhesive, for example a polyurethane adhesive, is dried in a through-oven by evaporation of the solvent and the aluminium foil coated with adhesive is then laminated with the PP Castfilm between two rollers into coated aluminium foil. The laminate adhesive used as an adhesion-promotion agent develops adequate adhesion in a relatively short time which leads to a seal seam strength to DIN 53539 of more than 5 N/15 mm.

The production of PP-coated aluminium foil by lacquer lamination of the foil with a PP Castfilm is relatively expensive. Therefore attempts have been made to replace the lacquer lamination with a PP Castfilm by a co-extrusion coating with PP. In current co-extrusion coating technology however, subsequent heat treatment is required to achieve adequate adhesion. This leads to after-crystallisation of the PP layer which causes increased adhesion of the moist or wet filling. Consequently, the serving properties deteriorate, i.e. the animal feed present in the form of a cohesive block can no longer be removed from the container by simple reversal of the container and light pressure with the thumbs on the base without additional aids. Similarly, for the same reason the moist or wet filling adheres or sticks to the lid. However, precisely this ease of serving and clean separation of the animal feed from the lid on opening the container is expected by the customer intending to present his cat or dog with feed in the form of a solid block.

As well as the negative effect on the serving properties and adhesion, the higher cystallinity of the PP layer caused by the retempering leads, on forming of the coated aluminium foil into containers, to so-called white break in the polymer which substantially reduces the resistance of the inside of the container to aggressive filling. The reduced resistance can lead to separation of the coating and hence corrosion of the metal below, where even a merely visual deterioration is not acceptable to the customer.

The problems do not arise in lacquer-laminated aluminium foil because of the largely amorphous surface structure of the PP Castfilm.

The present invention is therefore based on the task of creating a process of the type described initially which is cheaper than lacquer laminating with a PP Castfilm, where the coated aluminium foil produced with the process according to the invention, or containers and lids made from this for animal feed, have equally good properties with regard to ease of serving, adhesion and resistance to aggressive fillings as the lacquer-laminated foils according to the state of the art.

The task according to the invention is solved in that the plastic is co-extruded with an adhesion-promotion agent and combined with an aluminium foil between two rollers, the foil coextrusion-coated in this way, to increase the adhesion strength between the aluminium foil and plastic coating, then passes continuously through an oven with temperature set so that the temperature at the surface of the plastic coating lies above the crystallite melt point of the plastic and the coated aluminium foil heat-treated in this way, after emerging from the oven, is cooled in a shock-like manner such that the crystalline proportion at least in the surface area of the cooled plastic coating and the crystallites or spherulites in this area are as small as possible.

The essence of the invention therefore lies in the combination of the co-extrusion coating, which is cheaper than lacquer laminating, and the shock-like cooling of the surface of the plastic coating to reduce after-crystallisation, i.e. the obtaining of a mainly amorphous surface structure as is present in PP Castfilms.

The phrase “plastics based on polypropylene (PP) or polyethylene (PE)” here refers to both pure polymers which are normally known as PP-homo or PE-homo, and modified polymers with a majority of PP or PE. The term “modified polymers” for example includes the copolymers or terpolymers known as “random” with for example ethylene as a further monomer part, and the copolymers or terpolymers known as “block” or PP blends with other plastics, in particular polyethylene or fillers. Other examples are density-modified polyethylenes such as LDPE and HDPE. Generally, the polyethylenes have a behaviour comparable to polypropylene with regard to cystallinity. The key value which is decisive for the after-crystallisation of the PP and PE layers is the crystallite melt point of the polymer which defines the transition of a thermoplastic from its viscous molten state into the solid state characterised by crystallisation. The crystallite melt point for PP is around 160° C., for PE between 100° C. and 140° C. depending on density. The term “shock-like cooling” expresses the fact that the temperature range adjacent to the crystallite melt point is passed so quickly that firstly a substantial part of the surface area of the plastic layer remains in an amorphous state and secondly the cooling is so severe that the crystallites or spherulites crystallising out in a smaller amount are as fine as possible. The structure forming on the surface of the plastic layer, because of the low proportion of crystallites, leads to an effective suppression of the adhesion of animal feed described above, which gives better serving properties and reduced adhesion of the packaging container and lid made from the coated foil. The extremely small size of the crystallites and the high proportion of amorphous material essentially prevent the formation of white breaks even in the deformation area.

Suitable adhesion-promotion agents are for example co- and terpolymers modified for adhesion promotion with ethylene (E) or polypropylene (P) as one of the monomer components, in particular E.AA, E.MAA, E.VA, E.MA, E.EA, E.nBA, E.CO, E.VA.CO, E.nBA.CO, E.AE.AA, P.MAH, ionomers and similar, where preferably P.MAH is used.

The said monomer components mean:

| | |
|---|---|
| AA | acrylic acid |
| AE | acryl ester (MA, EA, BA) |
| nBA | n-butyl acrylate |
| CO | carbon monoxide |
| EA | ethyl acrylate |
| MA | methyl acrylate |
| MAA | methacrylic acid |
| MAH | maleic anhydride |
| VA | vinyl acetate |

The cooling speeds necessary to achieve the said properties and the lower limit of the temperature range which must be passed quickly, can be simply established by an expert in a few experiments for corresponding dimensioning of a cooling station.

Preferably, the temperature of the oven is at least 20° C. above the crystallite melt point of the polymer concerned. The start temperature for the shock-like cooling of the plastic layer also lies above the crystallite melt point of the plastic, where the end temperature of the shock-like cooling is preferably at least 40° below the crystallite melt point.

Also preferably the shock-like cooling is at least 80° C., preferably at least 100° C., below the crystallite melt point of the plastic.

The shock-like cooling speed of the plastic layer is generally greater than 10° C./sec, preferably greater than 50° C./sec, in particular greater than 100°/sec.

The shock-like cooling of the plastic layer can for example be performed by partial looping around at least one cooled roller. Other possibilities of shock-like cooling are for example direct cooling by means of a liquid or gaseous coolant, where here for ecological and cost reasons water is ideal, which can for example be further cooled with ice.

The coated aluminium foil can also be sprayed with the liquid coolant, preferably water. Finally, in certain cases it may be sufficient to cool the coated aluminium foil rapidly by means of a, preferably cooled, gas.

As already stated the process or the aluminium foil coated as made in the process, is preferably used for production of packaging for moist animal feed.

Preferred packages made from plastic-coated aluminium foil include in particular semi-rigid containers made by forming the coated aluminium foil, in particular a can or dish. These suitably have a closure in the form of a lid sealed onto the edge area of the container, which is preferably also made of the coated aluminium foil produced according to the invention. As stated above these packages are particularly suitable for moist animal feed.

Further advantages, features and details of the invention arise from the description below of preferred embodiments, and the drawings which show diagrammatically:

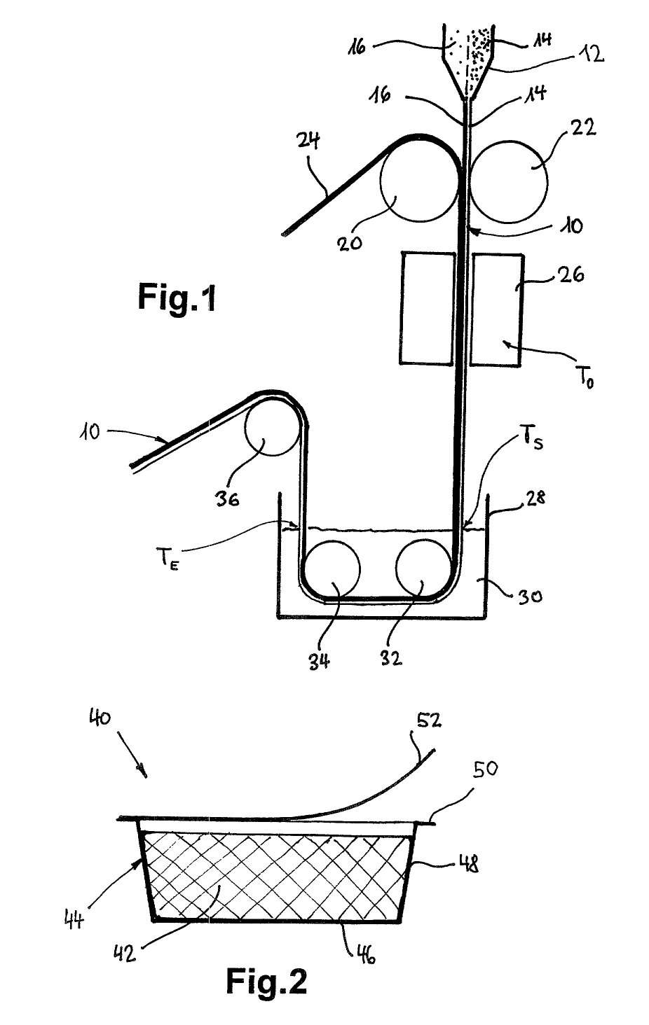

FIG. 1 the production of a coated aluminium foil;

FIG. 2 a cross section through a dish-like container for animal feed with partly removed lid.

The arrangement shown in FIG. 1 shows the essential process steps for producing a coated aluminium foil 10. A co-extrusion layer emerging from the nozzle 12 of a co-extrusion plant, not shown in the drawing, consists of a first plastic part 14 of for example polypropylene (PP) and a second plastic part 16 of an adhesion-promotion agent e.g. maleic acid-modified PP, and is combined in the gap of a roller pair 20, 22 with an aluminium foil 24 supplied by way of one of the two rollers 20. The coated aluminium foil 10 formed in this way, which still does not have sufficient adhesion to form a seal seam, after emerging from the roller gap passes through an oven 26 with an internal temperature T_{O} of for example 250° C. After emerging from the oven 26 the coated aluminium foil 10 is passed through a coolant 30, for example ice-cooled water, over deflector rollers 32, 34, 36 arranged in a coolant container 28. The temperature T_{S} of the coated aluminium foil 26 shortly before entering the coolant 30, i.e. the start temperature of the shock-like cooling, corresponds practically to the oven outlet temperature of for example 230° C. When the shock-cooled coated aluminium foil 10 leaves the coolant 30 the temperature T_{E}, i.e. the end temperature of the shock-like cooling, is for example 70° C. The coated aluminium foil 10 produced in this way is then, before further processing e.g. lacquering and/or printing of the outside and shaping of containers, wound into a coil not shown in the drawing. The external lacquering and/or printing can in principle be carried out before coating of the inside.

A packaging 40 shown in FIG. 2 for animal feed 42 consists of a dish-like container 44 with a base part 46 and a wall part 48 projecting from this, the upper edge 50 of which forms a peripheral sealing surface. On this upper edge is sealed a lid 52, partly removed in the figure, made of a coated aluminium foil 10. The base plastic of the cover material consists for example of PP and is also modified so that the lid 52 can easily be removed from the container edge 50 by peeling.

1. Process for production of an aluminium foil (10) coated with a sealable and sterilisable plastic (14) based on polypropylene (PP) or polyethylene (PE), characterised in that the plastic (14) is coextruded with an adhesion-promotion agent (16) and combined with an aluminium foil (24) between two rollers (20, 22), the aluminium foil (10) coextrusion-coated in this way, to increase the adhesion strength between the aluminium foil (24) and the plastic coating (14), then passes continuously through an oven (26) with temperature (T_{O}) set so that the temperature at the surface of the plastic coating (14) and the adhesion-promotion agent (16) lies above the crystallite melt point (T_{K}) of the plastic, and the coated aluminium foil (10) heat-treated in this way, after emerging from the oven (26), is cooled in a shock-like manner such that the crystalline proportion at least in the surface area of the cooled plastic coating (14) and the crystal grains in this area are as small as possible.

2. Process according to claim 1, characterised in that the temperature (T_{O}) of the oven (26) lies at least 20° C. above the crystallite melt point (T_{K}) of the plastic (14).

3. Process according claim 1 or 2, characterised in that the start temperature (T_{S}) for the shock-like cooling of the plastic layer (14) lies above the crystallite melt point (T_{K}) of the plastic (14) and the end temperature (T_{E}) of the shock-like cooling lies at least 40° C. below the crystallite melt point (T_{K}).

4. Process according to claim 3, characterised in that the end temperature (T_{E}) of the shock-like cooling is at least 60° C., preferably at least 80° C. below the crystallite melt point (T_{O}) of the plastic (14).

5. Process according to any of claims 1 to 4, characterised in that the shock-like cooling speed (V_{A}) of the plastic layer (14) is greater than 10° C./sec.

6. Process according to claim 5, characterised in that the shock-like cooling speed (V_{A}) is greater than 50° C./sec, preferably greater than 100° C./sec.

7. Process according to any of claims 1 to 6, characterised in that the shock-like cooling of the plastic layer (14) is carried out by partial looping over at least one cooled roller (20, 22).

8. Process according to any of claims 1 to 6, characterised in that the shock-like cooling of the plastic layer (14) is carried out by direct cooling by means of a liquid or gaseous coolant (30).

9. Process according to claim 8, characterised in that the coated aluminium foil (10) is passed through water, where applicable ice-cooled.

10. Process according to claim 8, characterised in that the coated aluminium foil (10) is sprayed with liquid coolant (30), preferably water.

11. Process according to claim 8, characterised in that the coated aluminium foil (10) is cooled by means of a gas, preferably a cooled gas.

12. Process according to any of claims 1 to 11, characterised in that as an adhesion-promotion agent (16), co- or terpolymers modified to promote adhesion with ethylene (E) or propylene (P) as one of the monomer components are used, in particular E.AA, E.MAA, E.VA, E.MA, E.EA, E.nBA, E.CO, E.VA,CO, E.nBA.CO, E.AE.AA or P.MAH, where Aa is acrylic acid, AE acryl ester, (MA, EA, BA), nBA n-butyl acrylate, CO carbon monoxide, EA ethyl acrylate, MA methyl acrylate, MAA methacrylic acid, MAH maleic anhydride and VA vinyl acetate.

13. Use of the process according to any of claims 1 to 12 or use of a coated aluminium foil (10) produced with the process according to any of claims 1 to 12, for production of a package (40) for moist animal feed (42).

14. Packaging made from an aluminium foil (24) coated with plastic (14) and produced with the process according to any of claims 1 to 12.

15. Packaging according to claim 14 in the form of a semi-rigid container (44) formed from the coated aluminium foil (10), in particular a can or dish.

16. Packaging according to claim 14 in the form of a peelable lid (52) made from the coated aluminium foil (10).

17. Packaging according to claim 15, characterised in that the container (14) has a peelable lid (52) of the coated aluminium foil (10) sealed to its edge area (50).

18. Use of the packaging according to any of claims 14 to 17 for moist animal feed.
